(19) United States
(12) Patent Application Publication
(10) Pub. No.: US 2013/0162329 A1
(43) Pub. Date: Jun. 27, 2013

(54) ANTI-FUSE CIRCUIT AND FUSE REPTURE METHOD THEREOF

(71) Applicant: Hoe Kwon JUNG, Icheon-si (KR)

(72) Inventor: Hoe Kwon JUNG, Icheon-si (KR)

(73) Assignee: SK HYNIX INC., Icheon-si (KR)

(21) Appl. No.: 13/602,236

(22) Filed: Sep. 3, 2012

(30) Foreign Application Priority Data
Dec. 22, 2011 (KR) 10-2011-0140460

(51) Int. Cl. H01H 37/76

(52) U.S. Cl. 327/525

(57) ABSTRACT

An anti-fuse circuit includes a control block configured to generate a first control signal and a second control signal in response to a first test signal and a second test signal, and a fuse set block configured to perform a primary fuse rupture operation in response to the first control signal and to perform a secondary fuse rupture operation in response to the second control signal, the fuse set block activating a fuse signal if any one of the primary fuse rupture operation and the secondary fuse rupture operation succeeds.

### CROSS-REFERENCES TO RELATED APPLICATION

The present application claims priority under 35 U.S.C. §119(a) to Korean application number 10-2011-0140460, filed on Dec. 22, 2011, in the Korean Intellectual Property Office, which is incorporated herein by reference in its entirety.

### BACKGROUND

1. Technical Field

The present invention generally relates to a semiconductor circuit, to an anti-fuse circuit, and a fuse rupture method thereof.

2. Related Art

An anti-fuse is a fuse that uses a transistor structure. It is a fuse that can be used in a manner in which a transistor performs like a conductor by rupturing, that is, breaking, a gate oxide material through applying a high voltage to the gate and the source (or a drain) of the transistor.

That is, before the rupture occurs the anti-fuse does not pass electricity, but after the rupture is performed the electricity is passed.

In the case of a general fuse, a fuse-cut operation to change the state of the fuse, for example, applying laser beams onto the fuse, is only possible in a state where the corresponding fuse is exposed, and thus the fuse-cut is only possible before packaging.

However, the anti-fuse can be ruptured through application of a high voltage even in a state where the fuse is not exposed, and thus its utility has wide range.

### SUMMARY

An embodiment of the present invention generally relates to an anti-fuse circuit and a fuse rupture method thereof, which can achieve a reliable rupture operation.

In an embodiment, an anti-fuse circuit includes: a control block configured to generate a first control signal and a second control signal in response to a first test signal and a second test signal; and a fuse set block configured to perform a primary fuse rupture operation in response to the first control signal and to perform a secondary fuse rupture operation in response to the second control signal, the fuse set block activating a fuse signal if any one of the primary fuse rupture operation and the secondary fuse rupture operation succeeds.

In an embodiment, a fuse rupture method of an anti-fuse circuit having a first anti-fuse cell and a second anti-fuse cell allocated with respect to one fuse signal includes: applying a high voltage pulse to the first anti-fuse cell during a first period; applying a high voltage pulse to the second anti-fuse cell during a second period; and activating the fuse signal if a rupture succeeds in any one of the first period and the second period.

According to the embodiments of the present invention, the reliability of the rupture operation can be improved through a stable rupture operation.

### BRIEF DESCRIPTION OF THE DRAWINGS

Features, aspects, and embodiments are described in conjunction with the attached drawings, in which:

FIG. 1 is a circuit diagram of an anti-fuse circuit according to an embodiment;

FIG. 2 is an operational timing diagram of an anti-fuse circuit according to an embodiment;

FIGS. 3A and 3B are circuit diagrams of an anti-fuse circuit according to an embodiment; and

FIG. 4 is an operational timing diagram of an anti-fuse circuit according to an embodiment.

### DETAILED DESCRIPTION

Hereinafter, embodiments will be described with reference to the accompanying drawings.

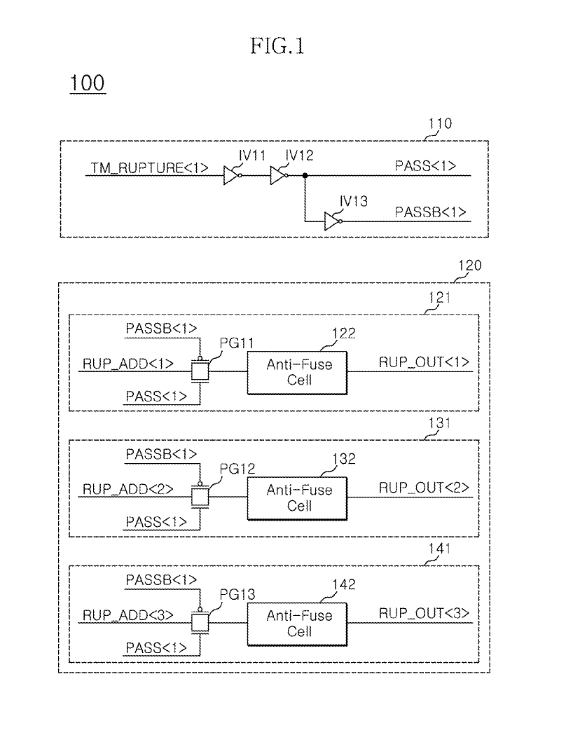

As illustrated in FIG. 1, an anti-fuse circuit 100 according to an embodiment may include a control block 110 and a fuse set block 120.

The control block 110 may be configured to generate control signals PASS<1> and PASSB<1> in response to a test signal TM_RUPTUR<1>.

The control block 110 may include a plurality of inverters IV11 to IV13.

The control block 110 may activate the control signals PASS<1> and PASSB<1> if the test signal TM_RUPTURE<1> is activated.

The fuse set block 120 may be configured to perform a fuse rupture operation in response to the control signals PASS<1> and PASSB<1> and rupture address signals RUP_ADD<1:3> (i.e., RUP_ADD<1>, RUP_ADD<2>, and RUP_ADD<3>), and to generate fuse signals RUP_OUT<1:3> according to the fuse rupture operation.

The fuse set block 120 may include a plurality of fuse sets, for example, first to third fuse sets 121 to 141, respectively.

The first fuse set 121 may include a pass gate PG11 and an anti-fuse cell 122.

The pass gate PG11 may provide the rupture address signal RUP_ADD<1> to the anti-fuse cell 122 in response to an activation of the control signals PASS<1> and PASSB<1>.

In this case, the rupture address signal RUP_ADD<1> is a high voltage pulse signal, and this high voltage may be a pumping voltage VPP that is used in a semiconductor circuit, for example, a semiconductor memory.

If the anti-fuse cell 122 is normal and the activated rupture address signal RUP_ADD<1> is normally provided to the anti-fuse cell 122, a rupture operation to break a gate oxide film of the anti-fuse cell 122 would normally be performed.

The second fuse set 131 may include a pass gate PG12 and an anti-fuse cell 132.

The pass gate PG12 may provide a rupture address signal RUP_ADD<2> to the anti-fuse cell 132 in response to the activation of the control signals PASS<1> and PASSB<1>.

If the anti-fuse cell 132 is normal and the activated rupture address signal RUP_ADD<2> is normally provided to the anti-fuse cell 132, the rupture operation to break the gate oxide film of the anti-fuse cell 132 would normally be performed.

The third fuse set 141 may include a pass gate PG13 and an anti-fuse cell 142.

The pass gate PG13 may provide a rupture address signal RUP_ADD<3> to the anti-fuse cell 142 in response to an activation of the control signals PASS<1> and PASSB<1>.

If the anti-fuse cell 142 is normal and the activated rupture address signal RUP_ADD<3> is normally provided to the anti-fuse cell 122, the rupture operation to break the gate oxide film of the anti-fuse cell 122 would normally be performed.

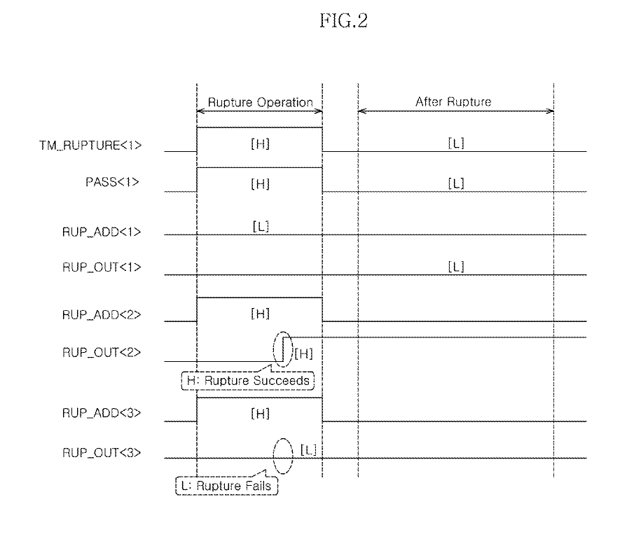

The operation of the anti-fuse circuit 100 according to an embodiment, as configured above, will be described with reference to FIG. 2.

At this time, it is assumed that the rupture address signals RUP_ADD<1:3> are at a logic low (i.e., [L]), high (i.e., [H]), and high, respectively, that is, “0”, “1”, and “1”, respectively. The rupture address signals RUP_ADD<1:3> may be information for determining whether to perform the rupture, and may have values of “0” or “1”. “1” to define that the rupture has been performed.

A test signal TM_RUPTURE<1> that may be activated during a set period to perform the fuse rupture operation may be activated.

The control signals PASS<1> and PASSB<1> may be activated in response to the test signal TM_RUPTURE<1>.

Since the rupture address signal RUP_ADD<1> may be logic low, the anti-fuse cell 122 of the first fuse set 121 may not ruptured, and thus the fuse signal RUP_OUT<1> of logic low may be output.

On the other hand, since the rupture address signal RUP_ADD<2> is logic high, the anti-fuse cell 132 of the second fuse set 131 is ruptured, and thus the fuse signal RUP_OUT<2> of logic high may be output.

Since the rupture address signal RUP_ADD<3> is logic high, the anti-fuse cell 142 of the third fuse set 141 is ruptured, and thus the fuse signal RUP_OUT<2> of logic high may be output.

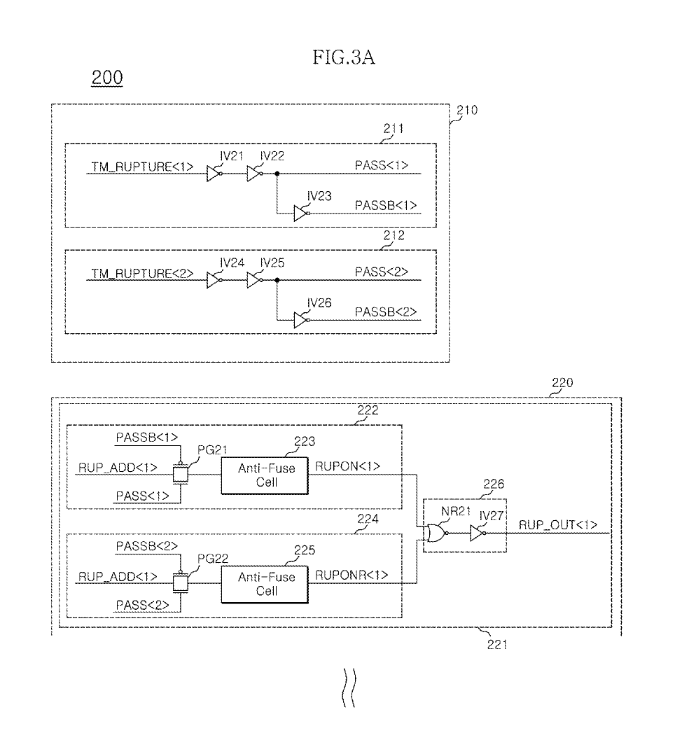

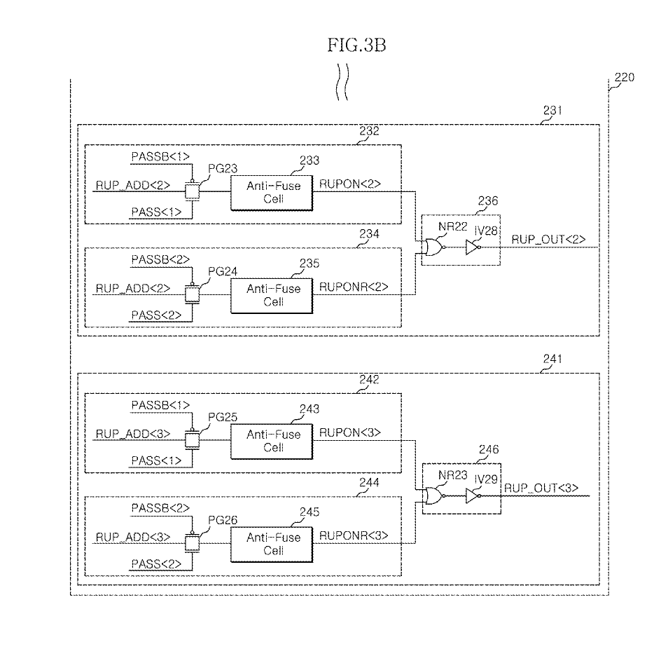

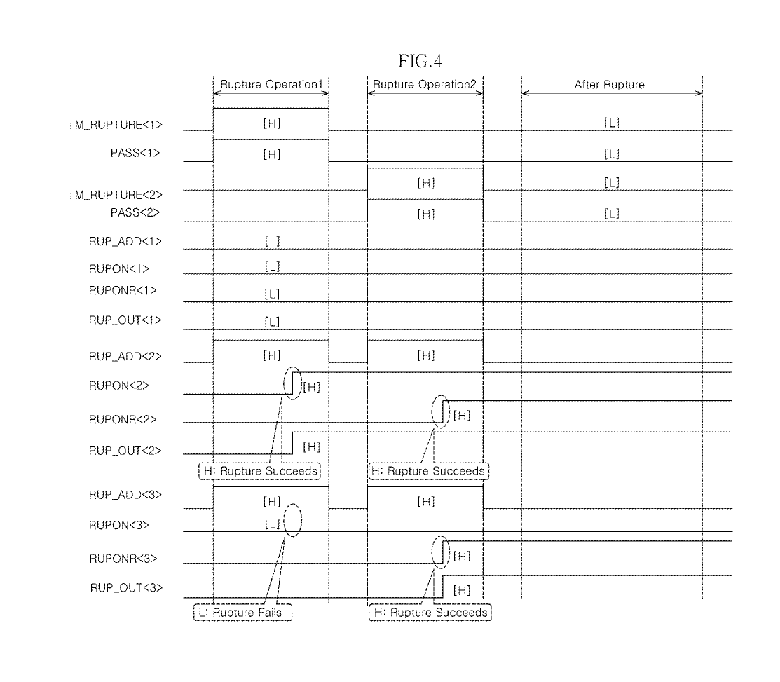

Hereinafter, referring to FIGS. 3A to 4, an anti-fuse circuit 200 according to an embodiment will be described below.

First, the anti-fuse circuit according to an embodiment is provided with an additional anti-fuse cell, and if, for example, the primary fuse rupture operation fails, an additional fuse rupture operation may be performed.

As illustrated in FIGS. 3A and 3B, the anti-fuse circuit 200 according to another embodiment may include a control block 210 and a fuse set block 220.

As illustrated in FIG. 3A, the control block 210 may be configured to generate first control signals PASS<1> and PASSB<1> and second control signals PASS<2> and PASSB<2> in response to a first test signal TM_RUPTURE<1> and a second test signal TM_RUPTURE<2>, respectively.

The control block 210 may include a first control unit 211 and a second control unit 212.

The first control unit 211 may be configured to generate the first control signals PASS<1> and PASSB<1> in response to the first test signal TM_RUPTURE<1>.

The first control unit 211 may include a plurality of inverters IV21 to IV23.

The first control unit 211 may activate the first control signals PASS<1> and PASSB<1> if the first test signal TM_RUPTURE<1> is activated.

The second control unit 212 may be configured to generate the second control signals PASS<2> and PASSB<2> in response to the second test signal TM_RUPTURE<2>.

The second control unit 212 may include a plurality of inverters IV24 to IV26.

The second control unit 212 may activate the second control signals PASS<2> and PASSB<2> if the second test signal TM_RUPTURE<2> is activated.

The fuse set block 220 may be configured to perform: a primary fuse rupture operation in response to the first control signals PASS<1> and PASSB<1> and the rupture address signals RUP_ADD<1:3>, to perform a secondary fuse rupture operation in response to the second control signals PASS<2> and PASSB<2> and the rupture address signals RUP_ADD<1:3>, and to activate the fuse signals RUP_OUT<1:3> if any one of the primary fuse rupture operation and the secondary fuse rupture operation succeed.

As illustrated in FIGS. 3A and 3B, the fuse set block 220 may include a plurality of fuse sets, for example, first to third fuse sets 221 to 241, respectively.

The first fuse set 221 may include a main fuse set 222, an auxiliary fuse set 224, and a signal combination unit 226.

The main fuse set 222 may be configured to perform the primary fuse rupture operation in response to the first control signals PASS<1> and PASSB<1> and the rupture address signal RUP_ADD<1>, and to generate a first preliminary fuse signal RUPON<1> according to the primary fuse rupture operation.

The main fuse set 222 may include a pass gate PG21 and an anti-fuse cell 223.

The pass gate PG21 may provide a rupture address signal RUP_ADD<1> to the anti-fuse cell 223 in response to the activation of the control signals PASS<1> and PASSB<1>.

At this time, the rupture address signal RUP_ADD<1> may be a high voltage signal, and this high voltage may be a pumping voltage VPP that is used in a semiconductor circuit, for example, a semiconductor memory.

If the anti-fuse cell 223 is normal and the activated rupture address signal RUP_ADD<1> is normally provided to the anti-fuse cell 223, the rupture operation to break the gate oxide film of the anti-fuse cell 223 would normally be performed, and thus the first preliminary fuse signal RUPON<1> would be activated.

The auxiliary fuse set 224 may be configured to perform the secondary fuse rupture operation in response to the second control signals PASS<2> and PASSB<2> and the rupture address signal RUP_ADD<1>, and to generate a second preliminary fuse signal RUPONR<1> according to the secondary fuse rupture operation.

The auxiliary fuse set 224 may include a pass gate PG22 and an anti-fuse cell 225.

The pass gate PG22 may provide the rupture address signal RUP_ADD<1> to the anti-fuse cell 225 in response to the activation of the second control signals PASS<2> and PASSB<2>.

If the anti-fuse cell 225 is normal and the activated rupture address signal RUP_ADD<1> is normally provided to the anti-fuse cell 225, the rupture operation to break the gate oxide film of the anti-fuse cell 225 would normally be performed, and thus the second preliminary fuse signal RUPONR<1> would be activated.

At this time, the anti-fuse cell 223 may be called a main fuse, and the anti-fuse cell 225 may be called an auxiliary fuse.

The signal combination unit 226 may activate the fuse signal RUP_OUT<1> if any one of a first preliminary fuse signal RUPON<1> and a second preliminary fuse signal RUPONR<1> is activated.

The signal combination unit 226 may include a NAND gate NR21 and an inverter IV27.

As illustrated in FIG. 3B, the second fuse set 231 may include a main fuse set 232, an auxiliary fuse set 234, and a signal combination unit 236.

The main fuse set 232 may be configured to perform the primary fuse rupture operation in response to the first control signals PASS<1> and PASSB<1> and the rupture address signal RUP_ADD<2>, and to generate a first preliminary fuse signal RUPON<2> according to the primary fuse rupture operation.

The main fuse set 232 may include a pass gate PG23 and an anti-fuse cell 235.

The pass gate PG23 may provide the rupture address signal RUP_ADD<2> to the anti-fuse cell 233 in response to the activation of the control signals PASS<1> and PASSB<1>.

At this time, the rupture address signal RUP_ADD<2> may be a high voltage signal, and this high voltage may be a pumping voltage VPP that is used in a semiconductor circuit, for example, a semiconductor memory.

If the anti-fuse cell 233 is normal and the activated rupture address signal RUP_ADD<2> is normally provided to the anti-fuse cell 233, the rupture operation to break the gate oxide film of the anti-fuse cell 233 would normally be performed, and thus the first preliminary fuse signal RUPON<2> would be activated.

The auxiliary fuse set 234 may be configured to perform the secondary fuse rupture operation in response to the second control signals PASS<2> and PASSB<2> and the rupture address signal RUP_ADD<2>, and to generate a second preliminary fuse signal RUPONR<2> according to the secondary fuse rupture to operation.

The auxiliary fuse set 234 may include a pass gate PG24 and an anti-fuse cell 235.

The pass gate PG24 may provide the rupture address signal RUP_ADD<2> to the anti-fuse cell 235 in response to the activation of the second control signals PASS<2> and PASSB<2>.

If the anti-fuse cell 235 is normal and the activated rupture address signal RUP_ADD<2> is normally provided to the anti-fuse cell 235, the rupture operation to break the gate oxide film of the anti-fuse cell 235 would normally be performed, and thus the second preliminary fuse signal RUPONR<2> would be activated.

The signal combination unit 236 may activate the fuse signal RUP_OUT<2> if any one of the first preliminary fuse signal RUPON<2> and the second preliminary fuse signal RUPONR<2> is activated.

The signal combination unit 236 may include a NAND gate NR22 and an inverter IV28.

As illustrated in FIG. 3B, the third fuse set 241 may include a main fuse set 242, an auxiliary fuse set 244, and a signal combination unit 246.

The main fuse set 242 may be configured to perform the primary fuse rupture operation in response to the first control signals PASS<1> and PASSB<1> and the rupture address signal RUP_ADD<3>, and to generate a first preliminary fuse signal RUPON<3> according to the primary fuse rupture operation.

The main fuse set 242 may include a pass gate PG25 and an anti-fuse cell 243.

The pass gate PG25 may provide the rupture address signal RUP_ADD<3> to the anti-fuse cell 243 in response to the activation of the control signals PASS<1> and PASSB<1>.

At this time, the rupture address signal RUP_ADD<3> is a high voltage signal, and this high voltage may be a pumping voltage VPP that is used in a semiconductor circuit, for example, a semiconductor memory.

If the anti-fuse cell 243 is normal and the activated rupture address signal RUP_ADD<3> is normally provided to the anti-fuse cell 243, the rupture operation to break the gate oxide film of the anti-fuse cell 243 would normally be performed, and thus the first preliminary fuse signal RUPON<3> would be activated.

The auxiliary fuse set 244 may include a pass gate PG26 and an anti-fuse cell 245.

The pass gate PG26 may provide the rupture address signal RUP_ADD<3> to the anti-fuse cell 245 in response to the activation of the second control signals PASS<2> and PASSB<2>.

If the anti-fuse cell 245 is normal and the activated rupture address signal RUP_ADD<2> is normally provided to the anti-fuse cell 245, the rupture operation to break the gate oxide film of the anti-fuse cell 245 would normally be performed, and thus the second preliminary fuse signal RUPONR<3> would be activated.

The signal combination unit 246 may activate the fuse signal RUP_OUT<3> if any one of the first preliminary fuse signal RUPON<3> and the second preliminary fuse signal RUPONR<3> is activated.

The signal combination unit 246 may include a NAND gate NR23 and an inverter IV29.

The operation of the anti-fuse circuit 200 according to an embodiment as configured above will be described with reference to FIG. 4.

It may be assumed that the rupture address signals RUP_ADD<1:3> are logic low, high, and high, respectively, that is, “0”, “1”, and “1”, respectively.

A first test signal TM_RUPTURE<1> that is may be activated during a set period to perform the fuse rupture operation is activated.

The first control signals PASS<1> and PASSB<1> may be activated in response to the first test signal TM_RUPTURE<1>.

A primary fuse rupture may be performed during the activation period of the first test signal TM_RUPTURE<1>.

Since the rupture address signal RUP_ADD<1> is logic low, the anti-fuse cell 223 of the first fuse set 221 is not ruptured, and thus the first preliminary fuse signal RUPON<1> is inactivated and the fuse signal RUP-OUT<1> of an inactivation level, that is, of logic low, is output.

On the other hand, since the second test signal TM_RUPTURE<2> is in an inactivation state, the anti-fuse cell 225 is not ruptured regardless of the rupture address signal RUP_ADD<1>, and thus the fuse signal RUP_OUT<1> is kept logic low.

Since the rupture address signal RUP_ADD<2> is logic high, the anti-fuse cell 233 of the second fuse set 231 is ruptured, the first preliminary fuse signal RUPON<2> is activated, and thus the fuse signal RUP_OUT<2> of logic high is output.

On the other hand, since the second test signal TM_RUPTURE<2> is in an inactivation state, the anti-fuse cell 235 is not ruptured regardless of the rupture address signal RUP_ADD<2>, and thus the second preliminary fuse signal RUPON<2> is kept in an inactivation state.

Since the rupture address signal RUP_ADD<3> is logic high, the anti-fuse cell 243 of the third fuse set 241 is ruptured.

However, the rupture of the anti-fuse cell 243 may fail due to physical or electrical problems. If the rupture fails, the first preliminary fuse signal RUPON<3> is inactivated, and thus the fuse signal RUP_OUT<3> of logic low is output.

On the other hand, since the second test signal TM_RUPTURE<2> is in an inactivation state, the anti-fuse cell 245 is not ruptured regardless of the rupture address signal RUP_ADD<3>, and thus the second preliminary fuse signal RUPON<3> is kept in an inactivation state.

According to an embodiment, a second fuse rupture operation can be performed to cope with the above-described rupture failure.

That is, after the inactivation of the first test signal TM_RUPTURE<1>, the second test signal TM_RUPTURE<2> is activated after a set timing.

The second control signals PASS<2> and PASSB<2> are activated in response to the second test signal TM_RUPTURE<2>.

A secondary fuse rupture may be performed during the activation period of the second test signal TM_RUPTURE<2>.

Since the rupture address signal RUP_ADD<1> is logic low, the anti-fuse cell 225 of the first fuse set 221 is not ruptured even if the second test signal TM_RUPTURE<2> is activated, and thus the second preliminary fuse signal RUPONR<1> is inactivated and the fuse signal RUP-OUT<1> of an inactivation level, that is, of logic low, is kept.

Since the rupture address signal RUP_ADD<3> is logic high, the anti-fuse cell 245 of the third fuse set 241 is ruptured, and thus the second preliminary fuse signal RUPON<3> is activated.

At this time, since the first and second preliminary fuse signals RUPON<3> and RUPONR<3> are all inactivated due to the rupture failure of the anti-fuse cell 243 during the primary fuse rupture operation, the fuse signal RUP_OUT<3> has not been activated.

However, the second preliminary fuse signal RUPONR<3> is activated through the secondary fuse rupture operation, and thus the fuse signal RUP_OUT<3> is activated.

As described above, according to the present invention, even if the fuse rupture fails due to any internal problems, a normal fuse rupture can be performed through an additional rupture operation.

While certain embodiments have been described above, it will be understood to those skilled in the art that the embodiments described are by way of example only. Accordingly, the semiconductor memory apparatus described herein should not be limited based on the described embodiments.

What is claimed is:

1. An anti-fuse circuit comprising:
a control block configured to generate a first control signal and a second control signal in response to a first test signal and a second test signal; and
a fuse set block configured to perform a primary fuse rupture operation in response to the first control signal and to perform a secondary fuse rupture operation in response to the second control signal, the fuse set block activating a fuse signal if any one of the primary fuse rupture operation and the secondary fuse rupture operation succeeds.

2. The anti-fuse circuit of claim 1, wherein the fuse set block comprises:
a main fuse set configured to perform the primary fuse rupture operation in response to the first control signals and the rupture address signal and to generate a first preliminary fuse signal according to the primary fuse rupture operation.

3. The anti-fuse circuit of claim 2, wherein the fuse set block comprises:
an auxiliary fuse set configured to perform the secondary fuse rupture operation in response to the second control signals and the rupture address signal and to generate a second preliminary fuse signal according to the secondary fuse rupture operation.

4. The anti-fuse circuit of claim 3, wherein the fuse set block comprises:
a signal combination unit configured to activate the fuse signal if any one of the first preliminary fuse signal and the second preliminary fuse signal is activated.

5. The anti-fuse circuit of claim 4, wherein the main fuse set comprises:
an anti-fuse cell.

6. The anti-fuse circuit of claim 5, wherein the main fuse set comprises:
a pass gate configured to provide the rupture address signal to the anti-fuse cell in response to an activation of the first control signal.

7. The anti-fuse circuit of claim 4, wherein the auxiliary fuse set comprises:
an anti-fuse cell.

8. The anti-fuse circuit of claim 7, wherein the auxiliary fuse set comprises:
a pass gate configured to provide the rupture address signal to the anti-fuse cell in response to an activation of the second control signal.

9. The anti-fuse circuit of claim 4, wherein the rupture address signal is a high voltage pulse signal.

10. A fuse rupture method of an anti-fuse circuit having a first anti-fuse cell and a second anti-fuse cell allocated with respect to one fuse signal, comprising:
applying a high voltage pulse to the first anti-fuse cell during a first period;
applying a high voltage pulse to the second anti-fuse cell during a second period; and
activating the fuse signal if a rupture succeeds in any one of the first period and the second period.
